(19) United States
(12) Patent Application Publication
(10) Pub. No.: US 2011/0052805 A1
(43) Pub. Date: Mar. 3, 2011

(54) METHOD AND SYSTEM FOR DEPOSITING A METAL OR METALLOID ON CARBON NANOTUBES

(75) Inventors: Serge Bordere, Jurancon (FR); Daniel Cochard, Argagnon (FR); Eric Dutilh, Cescau (FR); Patrice Gaillard, Hagetaubin (FR); Damien Voiry, Joue-Les-Tours (FR)

(73) Assignee: Arkema France, Colombes (FR)

(21) Appl. No.: 12/920,347

(22) PCT Filed: Feb. 20, 2009
(86) PCT No.: PCT/FR09/50274

§ 371 Date: Sep. 16, 2010

(30) Foreign Application Priority Data
Mar. 11, 2008 (FR) 08 51581

(51) Int. Cl. B05D 7/24; B82Y 40/00

(52) U.S. Cl. 427/217; 427/215; 977/847

(57) ABSTRACT

The invention relates to a method and a system for depositing a metal or a metalloid on carbon nanotubes (NTC). The method of the invention comprises homogenising an NTC powder in a reactor, and depositing said metal or metalloid on the homogenised NTC powder using a chemical vapor deposition technique implemented inside the reactor from a precursor comprising an alkyl of said metal or metalloid. The method can be used for the production of nanostructured SiC at the surface of the NTC by Si deposition on said NTC.

The invention relates to a process and an industrial system for depositing a metal or metalloid on carbon nanotubes (CNTs).

Carbon nanotubes are reinforcing materials that are very promising for manufacturing metal matrices (manufacture of metal-CNT alloy) or composite ceramics. However, tests have shown, in such applications, that the mechanical properties of the CNTs are lower than those expected. Several reasons that explain these results have been found.

On the one hand, the CNTs have a tendency to interact with the metal matrix when they are placed in an oxidizing atmosphere which degrades their structure and their properties and reduces their reinforcing property. Furthermore, the interfacial bond between the CNTs and the metal matrix is weak, which increases the risks of loss of cohesion.

Moreover, during the preparation of a metal-CNT alloy, the temperatures achieved generate a reaction between the carbon nanotubes, which produces carbides. This impairs the microstructure and the interfacial properties of the nanotubes.

In order to solve this problem, several approaches have been proposed:

1—A first approach proposed consists in depositing a layer of inorganic material such as a metal onto the walls of the carbon nanotubes.

In order to do this, there are several deposition methods:

a)—The Wet Route:

This method is simple and can be carried out at low temperature. However, it is difficult to completely rinse the residues of the products and to accurately control the size of the particles deposited at the surface of the CNTs. Furthermore, the high surface tension and the high hydrophobicity of the CNTs makes them difficult to wet. Finally, the particles may fill the cavities of the CNTs in an uncontrollable manner.

b)—The Vapor Route (Physical Vapor Deposition PVD or Metal Organic Chemical Vapor Deposition CVD).

The vapor route improves control of the deposition the best since it is possible to vary the flow rates and the exposure time. The growth of the particles at the surface of the CNTs can thus be accurately controlled. Nevertheless, the absence of suitable reactive molecules limits the application of this method for a metallic deposition.

Moreover, deposition experiments carried out on CNTs have shown that it was difficult to succeed in perfectly depositing a fine and homogeneous film at the surface of the CNTs. This is because these techniques are applicable to flat substrates; their effectiveness is reduced for the nanotubes and a fortiori for bundles of nanotubes.

c)—The Solid Route:

Various solid-route methods have been attempted for improving vapor deposition processes.

One method for depositing tin dioxide by injecting an SnH₄ precursor into a reactor heated at 550° C. and at a pressure of 23.2 Torr, i.e. 3×10⁻² bar, is described in the document “Controllable fabrication of SnO₂-coated multiwalled carbon nanotubes by chemical vapor deposition” by Q. Kuang et al.; Carbon, 44 (2006), pp. 1166-1172. This method requires a purification of the CNTs using nitric acid.

One method, described for example in patent US 2006/0043649 A1 was developed for the deposition of boron. This method consists in mixing MgB₂ powder with CNTs purified with hydrofluoric acid (HF). Once mixed, the assembly is covered with a thallium foil and placed in a furnace at 1100° C. and at a pressure of 0.5 Torr, i.e. 6×10⁻⁴ bar.

One method, described in the document entitled “Carbon Nanotubes Coated with Alumina as Gate Dielectrics of Field Transistor” by L. Fu, Z. Liu, et al., Adv. Matter, 2006, 18, pp. 181-185, was developed for depositing aluminum. This method uses the supercritical route. The CNTs are dissolved in a solution of ethanol containing aluminum nitrate nonahydrate. Supercritical CO₂ is injected at 35° C. A mixed solution of ethanol and of CO₂ forms and dissolves the aluminum nitrate nonahydrate. The assembly is then heated at 80° C. for 6 hours.

To conclude, copper deposition experiments have been attempted starting from organic precursors, especially copper (II) acetylacetonate. The CNTs are purified with nitric acid, then impregnated by the precursor and then placed in a furnace at 300° C. with a flow of hydrogen of 200 ml/minute for 30 minutes. This experiment is described in the document entitled “Preparation of Copper Coated Carbon Nanotubes by Decomposition of Cu(II) acetylacetonate in Hydrogen Atmosphere”, G. Wenli, Z. Yue, L. Tongxiang, J. Mater. Sci., 41, 2006, pp. 5462-5466.

These techniques are difficult to transpose to a continuous production and require restrictive conditions. Furthermore, the CNTs must be purified in order to improve the deposition efficiency.

2—A second approach consists in depositing a protective layer of silicon onto the walls of the nanotubes using the CVD technique by the in situ decomposition of a silicon-loaded gas.

Specifically, the paper entitled “Effect of Chemical Vapor Deposition Energy Sources on the Structure of SiC Prepared by Carbon Nanotubes-Confined Reaction”, J. Vac. Sci. Technol., B21(3), May/June 2003, published on May 27, 2003, describes a process for obtaining CNTs comprising, at the surface, nanostructured silicon carbide (SiC) starting from a precursor containing silicon, such as tetramethylsilane (TMS).

The conversion of the tetramethylsilane is carried out in a small-capacity reactor operating in batch mode and takes place at a temperature above 1100° C. and under a pressure of 10 mbar.

This process cannot be exploited in industrial-scale manufacture due to the restrictive conditions which are imposed for the temperature and the pressure.

Reference may also be made to the prior art constituted by the document D1 corresponding to the publication by Serp, P. et al., entitled “Controlled-growth of platinum nanoparticles on carbon nanotubes or nanospheres by MOCVD in fluidized bed reactor”, Journal de Physique IV, Editions de Physique, Les Ulis Cedex FR, vol. 12, No. 4, 1 Jun. 2002 (Jun. 1, 2002), pages PR4-29, XP009062695 ISSN: 1155-4339. This is a process for depositing platinum on to CNTs using the CVD deposition technique. This publication more particularly describes the experimental conditions that make it possible to deposit platinum on CNTs by fluidized-bed CVD deposition. These conditions impose a low pressure, below atmospheric pressure, and a chemical (acid) treatment of the CNTs in order to allow the attachment of the platinum to the CNTs. This process applies to the production of catalyst supports.

Described in the document D2, WO 2007/088292 A (Commissariat Energie Atomique [Atomic Energy Commission]), is a process for manufacturing an electrode for an electrochemical reactor. In this process, the deposition of the catalyst is carried out by DLI-MOCVD on CNTs. The catalyst is platinum. The process in this case consists in spraying platinum (liquid route) onto a diffusion layer made from porous carbon constituted by CNTs placed on a substrate. The possible applications are the same as for D1.

Described in the document D3, entitled “Microstructure and Thermal Characteristic of Si Coated Multiwalled Carbon Nanotubes”, Y. H. Wang, Y. N. Li, J. B. Zang, H. Huang, Nanotechnology, 17, 2006, pp. 3817-3821, is a process for depositing Si onto CNTs. This process is similar to the second approach described previously. However, in this case, silane (SiH₄) is used as the precursor. Moreover, the deposition takes place via successive deposition cycles. Several vacuum and gas injection cycles are necessary in order to allow a sufficient deposition. The temperatures are of the order of 550° C. and the vacuum is driven to 10⁻⁶ mbar. One cycle lasts several hours. A continuous production cannot be envisaged with this technique. The CNTs require a heat treatment (at 550° C.)

It is clear that all the methods described previously are difficult to transpose to a continuous production and consequently none enables a true industrial exploitation to be implemented. This is because certain methods impose restrictive conditions, in particular as regards the temperature and the pressure, and/or have a batch character or impose a purification of the CNTs (heat treatment).

In any case, no process described makes it possible to propose an industrial solution that can truly be exploited for the deposition, onto CNTs, of metals, such as tin, aluminum or copper, or of metalloids, that is to say semiconductors such as silicon, boron or germanium. The process according to the invention provides a solution without it being necessary to treat the CNTs, the CNTs possibly being raw, and with non-restrictive conditions, namely a temperature below 1000° C. and a pressure which is atmospheric pressure.

The present invention makes it possible to thus overcome the drawbacks of the prior art. The solution proposed is a process for depositing a metal or metalloid, which may be in organic form, onto carbon nanotubes (CNTs), the implementation of which takes place under moderate conditions: a temperature that does not exceed 1000° C. and at atmospheric pressure. With the process proposed, it is not at all necessary to purify (treat) the nanotubes; raw CNTs may be used. Moreover, the process may be carried out continuously. It thus provides an industrial solution to the manufacture of CNTs covered with a protective layer of, for example, Si (silicon), Ge (germanium) or B (boron) or else Al (aluminum), Cu (copper) or Sn (tin); thus improving the thermal, conductive and mechanical properties of the materials comprising said nanotubes in their composition. The process according to the present invention has applications such as the manufacture of materials in the form of a conductive matrix or composite ceramic for aeronautics, metallurgy, motor vehicles and integrated circuits.

One subject of the present invention is more particularly a process for depositing a metal or metalloid onto carbon nanotubes (CNTs), mainly characterized in that it comprises:
the homogenization of a CNT powder in a reactor,
the deposition on this homogeneous CNT powder of said metal, chosen from tin, aluminum or copper, or of said metalloid, chosen from silicon, boron or germanium; by means of a vapor deposition technique carried out inside the reactor starting from a precursor formed from an alkyl of this metal or metalloid; the vapor deposition being carried out in the reactor at atmospheric pressure and at a temperature below 1000° C., the precursor being injected into the reactor in the form of gas.

The precursor in the liquid state is converted to the vapor phase by heating and injected in the form of gas or transported by means of a gas so as to be injected in the form of gas.

In one exemplary embodiment corresponding to a batch production, a predetermined amount of raw CNTs is introduced cold into the reactor, the gas is injected in order to form the homogeneous powder of CNTs by placing the CNTs in a fluidized bed, the reactor is heated to a predefined temperature of less than 1000° C., when the predefined temperature is reached, the precursor is injected into the reactor and decomposes at the surface of the CNTs, the reactor comprises an outlet that makes it possible to recovery the CNTs covered by the deposited material.

In order to obtain a continuous industrial operation, the reactor used comprises a continuous inlet for raw CNTs and a low discharge outlet that thus makes it possible, owing to gravity, to recover the CNTs covered by the deposited material throughout the operation, the CNTs being formed remaining in suspension in the reactor.

In the case of the deposition of silicon (Si), tetramethylsilane (TMS) is preferably chosen as the precursor.

The gas that is used for the injection of the TMS vapor may be hydrogen; it thus makes it possible to dilute the TMS and to avoid the formation of coke.

The gas that is used to obtain the purging for the fluidized bed may be an inert gas or hydrogen.

The process makes it possible to manufacture nanostructured silicon carbide (SiC) at the surface of the CNTs.

The process applies to the manufacture of metal matrices or composite ceramics.

Another subject of the invention is a system for implementing the process comprising a reactor in which the vapor deposition is carried out, said reactor comprising an inlet for receiving the raw CNTs, an inlet for injecting a gas, means for obtaining a fluidized bed of CNT powder under the injection of the gas, an inlet for receiving the precursor that makes it possible to obtain the vapor phase deposition, an outlet for discharging the CNTs covered with the deposited material obtained by the vapor phase deposition, said system also comprising flow control means for the introduction of the precursor into the reactor.

These means comprise a flow meter placed in the circuit of the precursor after conversion of the latter to the vapor phase and a flow meter placed in the circuit of the gas for transporting and diluting the precursor.

The CNTs may be supplied in a measured amount from a storage container or continuously from a transport pipe.

The system may also comprise a device for converting the precursor to the vapor phase and a flow controller for injecting the precursor in the form of vapor into the reactor at a given flow rate with the gas that makes it possible to dilute said precursor and thus reduce contact overconcentrations (in order to avoid the formation of coke).

The invention applies to the manufacture of nanostructured silicon carbide (SiC) at the surface of the CNTs.

The invention also applies to the manufacture of metal matrices or of composite ceramics.

Other features and advantages of the invention will appear clearly on reading the description that is presented below and that is given by way of illustrative and non-limiting example and with respect to the figures, in which:

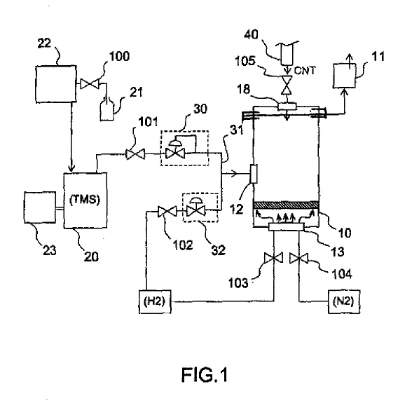

FIG. 1 represents a diagram of a system for implementing the invention,

FIG. 2 represents a graph that illustrates the change in the ash content for a deposition of Si in the vapor phase onto nanotubes as a function of the TMS/CNT ratio and that of raw CNTs,

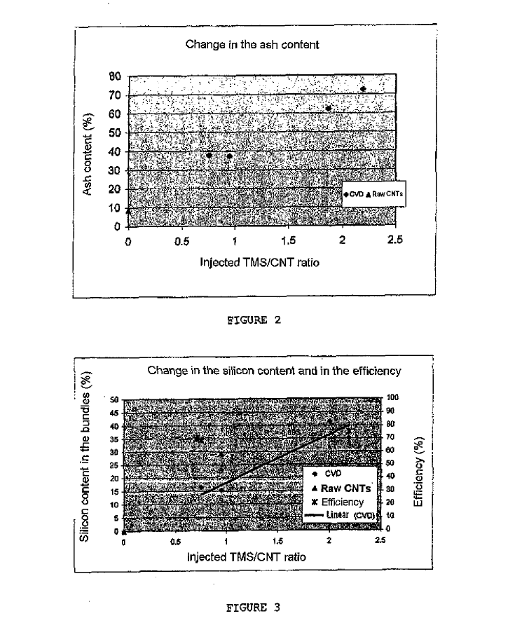

FIG. 3 represents a graph illustrating the change in the silicon content and in the efficiency as a function of the TMS/CNT ratio for the various tests,

FIG. 4 represents the X-ray spectrum of sample 401,

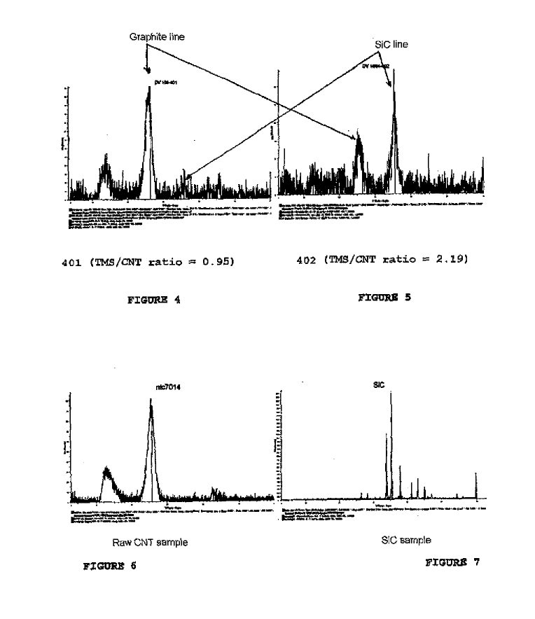

FIG. 5 represents the X-ray spectrum of sample 402,

FIG. 6 represents the X-ray spectrum of the raw CNT reference sample,

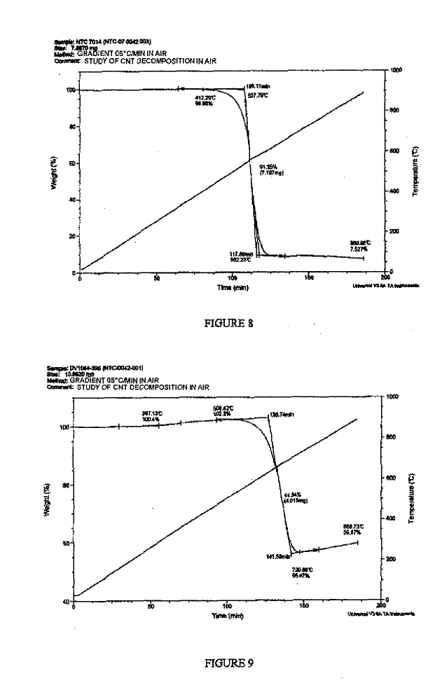

FIG. 7 represents the X-ray spectrum of an SiC sample,

FIG. 8 represents the curve of behavior with respect to the temperature, in air, of raw CNTs,

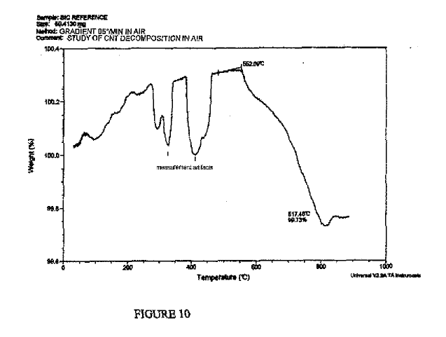

FIG. 9 represents the curve of behavior with respect to the temperature, in air, of silicon-covered CNTs, and

FIG. 10 represents the curve of behavior with respect to the temperature, in air, of an SiC sample.

The description which follows relates to an example of practical implementation of the process in the case of a deposition of silicon (Si) by CVD using, as precursor, tetramethylsilane (TMS). The deposition of Si onto CNTs makes it possible to obtain nanostructured SiC at the surface of the CNTs.

The TMS is injected into a reactor 10 where it decomposes and silicon resulting from this decomposition is deposited on the nanotubes.

The reactor is a fluidized-bed reactor having a diameter of 5 cm (2 inches).

The TMS is introduced into an inerted, jacketed vessel 20 by vacuum suction directly from a bottle 21 of TMS. The TMS is heated using a thermostatically controlled bath 23 at a temperature between 50 and 65° C. for a relative pressure of 1.6 bar so as to be able to be introduced in vapor form into the reactor and to be able to control its flow rate. The CNT powder is placed in the fluidized-bed reactor 10 through an inlet 18 placed on the top of the reactor 10. The inlet 18 may be fed by a storage container or by a transport pipe 40.

In practice, the temperature of the thermostatically-controlled bath is 62° C., and the vessel 20 is a stainless steel vessel (1 l).

The reactor 10 is heated at 850° C. under a purge of a gas injected via an inlet 13 located underneath the reactor 10. In a first phase corresponding to the period of heating the reactor, the gas is an inert gas, for example nitrogen (N₂), then, in a second phase, when the internal temperature of the reactor reaches 850° C., the nitrogen inlet is closed and the gas injected via the inlet 13 is then hydrogen.

When the reactor 10 has reached the desired temperature, the TMS vapor is injected via an inlet 12 into said reactor 10 at a flow rate controlled by means of a mass flow meter 30. The TMS vapor is conveyed into the reactor 10 by a slight stream of hydrogen that follows the same circuit 31 as the TMS. The flow rate of the hydrogen is controlled by the flow meter 32.

The hydrogen is mixed with the TMS in order to dilute the TMS and to prevent contact overconcentrations, thus avoiding the deposition of carbon.

The reactor is maintained at a temperature of 850° C. during the entire TMS injection time.

The TMS in the form of heated vapor decomposes and silicon is deposited on the CNT powder. The by-products of the reaction are sent toward the torch 11 on exiting the reactor 10.

Only a few valves have been represented by way of example in the circuits connecting the various components of the system represented in FIG. 1. These valves bear the references 100 to 105 in this figure and may be controlled conventionally, manually or automatically by a machine programmed for this purpose (machine not represented). This same machine may also be programmed in order to automatically control the devices for controlling the flow rate of the TMS and of the hydrogen.

Various tests have been carried out under the operating conditions summarized in the table below in order to demonstrate the effectiveness of the process.

For 20 g of CNT injected into the reactor (height of the CNT bed in cm):

| | | Test 2 | Test 3 | Test 4 |
|---|---|---|---|---|
| | Test 1 | (Sample | (Sample | (Sample |
| | (Sample 395) | 397) | 401) | 402) |
| Mass of CNT recovered (g) | 22 | 22.1 | 20.4 | 21.7 |
| Height of the bed (cm) | 9.3 | 9.4 | 8.6 | 9.3 |
| Mass of TMS injected (g) | 43.9 | 19.6 | 19.3 | 47.5 |
| Mass of silicon injected | 14 | 6.2 | 6.1 | 15.2 |
| (g) | | | | |
| TMS flow rate (l/h) | 6.8 | 3.4 | 6.8 | 6.8 |
| Hydrogen flow rate (l/h) | 200 | 200 | 200 | 200 |
| Hydrogen flow rate for | 12 | 12 | 12 | 12 |
| injection (l/h) | | | | |
| Temperature of the | 850 | 850 | 850 | 850 |
| reactor (° C.) | | | | |
| Temperature of the bath | 62.7 | 62.7 | 62.7 | 62.7 |
| (° C.) | | | | |

It can be seen in this table that, when a mass of 43.9 g of TMS [(CH₃)₄—Si] is injected, 14 g of Si are injected, for 19.3 g of TMS, 6.1 g of Si are injected and, for 47.5 g of TMS, 15.2 g of Si are injected.

It is observed that, for the various tests carried out, the mass of CNT recovered is greater than the mass of the CNTs injected. A deposition of Si has taken place on the CNTs resulting from the decomposition of TMS. This deposition changes with the mass of TMS injected and its flow rate.

Among all the organic molecules, TMS was chosen since it is the best compromise between the volatility and the length of the carbon-based chains of the ligands.

In the case where the precursor used would be silane or disilane, the decomposition may take place at a temperature of 400° C.; for TMS, the decomposition takes place at 650° C.

Detection of silicon in the deposited material was confirmed by various measurements:

1) Ash Content Measurements:

These measurements make it possible, as will be seen in FIGS. 2 and 3, to demonstrate that silicon carbide is obtained and that consequently deposition of silicon has indeed taken place.

FIG. 2 shows the ash content as a function of the TMS/CNT ratio for a raw CNT sample compared to the change in this content for a sample on which a deposition of Si by CVD according to the invention has been carried out.

FIG. 3 shows the change in the Si content and the efficiencies obtained according to the various tests:

Sample 397, TMS/CNT: 0.75; ash content: 37.81

Sample 395, TMS/CNT: 0.94; ash content: 37.41

Sample 402, TMS/CNT: 1.86; ash content: 62.26

Sample 401, TMS/CNT: 2.18; ash content: 72.4.

The Si content increases from 15% to more than 35% when the amounts of TMS are doubled.

The measurement conditions were the following:

The ash contents were produced at 800° C. over one hour.

For the sample of raw nanotubes taken as a reference in FIG. 2, the ash content is equal to 8.7%.

It is observed that, with the deposition process used, the ash contents vary almost linearly with the change in the injected TMS/CNT ratio. An ash content greater than 70% is obtained in the case of the ratio of 2.19, that is to say for sample 401. The presence of SiC is confirmed.

2) X-Ray Analysis:

The various spectra obtained are represented in FIGS. 4 to 7.

All the samples resulting from tests 1 to 4 were subjected to X-rays. They were compared to the spectra of the reference products, namely the sample of raw nanotubes (FIG. 6) and the silicon carbide SiC (FIG. 7).

FIG. 4 represents the spectrum of the sample 401 with a TMS/CNT ratio=0.95 and FIG. 5 represents the spectrum of the sample 402 with a TMS/CNT ratio=2.19.

FIG. 6 illustrates the spectrum of the reference raw CNT sample and displays the graphite line that is found in FIGS. 4 and 5. FIG. 7 illustrates the spectrum of the SiC sample.

The reference SiC, FIG. 7, is a 2 mm powdered product which was milled for the X-ray analyses, sold by VWR Prolabo.

The fine lines are very clearly seen in the SiC spectrum, FIG. 7, and the lines definitely of SiC are identified in the sample with a ratio equal to 2.19 represented in FIG. 5.

Regarding the sample with the ratio equal to 0.95, the SiC lines are present but are less clear.

In the two samples from FIG. 4 and FIG. 5, the SiC lines are not as fine as for the reference sample. The organization of the crystal is therefore not as perfect.

In the two samples illustrated by FIGS. 4 and 5, the lines of the graphite carbon, characteristic of carbon nanotubes, are also found. Their structure therefore appears to be retained.

The X-ray measurements show that:

Silicon carbide has indeed been deposited on the nanotubes.

The peaks are more pronounced for large amounts of injected TMS.

In order to determine more precisely the chemical nature of the surface deposited material, the applicant has used an ESCA (Electron Spectroscopy for Chemical Analysis) or XPS (X-Ray Photoelectron Spectroscopy) approach.

Clearly, it has been demonstrated that the fluidized-bed CVD deposition process developed makes it possible to achieve a deposition of silicon in a large amount (up to 40% in the tests). Moreover, the efficiencies obtained exceed 60%.

The deposited material is constituted of SiC (silicon carbide) and of an oxidized layer in SiOₓC_{y} form. Moreover, the SiC/SiOₓC_{y} ratio increases with the injected precursor/CNT ratio, which the results of the X-ray analyses confirm.

The deposition takes place in the form of Si and the carbon of the SiC originates from the walls of the nanotubes. The hydrogen used for preventing the deposition of carbon has entirely fulfilled its role and no deposition of carbon has been detected.

Furthermore, analyses using an electron microscope have shown that the deposited material produced is homogeneous between the bundles and on the very inside of a bundle.

The applicant has also examined the behavior with respect to the temperature and in air of the CNTs covered with silicon according to the process.

The operating conditions were the following:

Temperature gradient: 5° C./min up to 900° C.;

Sample examined (395) resulting from the first test.

FIGS. 8 and 9 respectively represent the variations in the mass over time, of the sample of raw CNTs taken as reference and of the sample examined 395 (test 1), as a function of the temperature variations. The operating conditions are the application of a temperature gradient of 5° C./min up to 900° C., in air, as illustrated on the right in FIGS. 8 and 9. FIG. 10 represents the variation in the mass of SiC over time as a function of the temperature variation.

The decomposition of the CNTs is shifted to 644° C. versus 538° C. for the raw CNTs (reference sample), i.e. an improvement of 20%.

The mass of the sample 395 resulting from the first test increases from 290° C. and above all after 720° C., which corresponds to the oxidation of the deposited material.

By comparison, the SiC thermogram represented in FIG. 10 shows a slight increase in the mass of the order of 0.4% before 550° C. Then, the mass drops abruptly before stabilizing at 99.7% of its initial mass at a temperature of 817° C.

The weight gain at the beginning may be attributable to the formation of SiO₂ from the SiOₓC_{y} which is at the surface. The SiC is not, itself, decomposed.

If the sample examined is returned to, the gain in weight from 290° C. originates from the oxidation of the SiOₓC_{y} (surface formation of SiO₂).

Finally, the increase in the weight at high temperature may be explained by the oxidation of SiC.

The temperature behavior for the sample examined is improved by close to 20% and the decomposition at temperature is pushed back, as can be seen from FIGS. 8 and 9.

The table below makes it possible to illustrate, besides the example of a deposition of Si onto CNTs under the conditions of the present invention, other examples of deposition onto CNTs with semiconductors, such as boron or germanium, and of deposition onto CNTs with metals, such as aluminum, copper and tin; the precursors chosen and the temperature and pressure conditions.

| Metals/ | | | |
|---|---|---|---|
| semi- | | Temperature | |
| conductors | Precursor | (° C.) | Pressure |
| Si | TMS | 650 < T < | Atmospheric |
| | | 1000 | |
| B | Trimethylboron | 650 < T < | Atmospheric |
| | Triethylboron | 1000 | |
| Ge | Diethylgermanium | 300 < T < | Atmospheric |
| | Tetraethylgermanium | 750 | |
| Al | Trimethylaluminum | 300 < T < | Atmospheric |
| (T_{melting} = | | 750 | |
| 660° C.) | | | |
| Cu | Cu(II) acetylacetonate | 300 < T < | Atmospheric |
| | Cu(I) | 750 | |
| | hexafluoroacetylacetonate | | |
| | 2-methyl-1-hexen-3-yne | | |
| Sn | Tetramethyltin | 400 < T < | Atmospheric |
| (T_{melting} = | | 750 | |
| 231° C.) | | | |

1. A process for depositing a metal or metalloid onto carbon nanotubes (CNTs), characterized in that it comprises:
homogenizing a CNT powder in a reactor,
depositing on homogeneous CNT powder metal, chosen from tin, aluminum or copper, or metalloid, chosen from silicon, boron or germanium; by means of a vapor deposition carried out inside the reactor, at atmospheric pressure and at a temperature below 1000° C., starting from a precursor formed from an alkyl of the metal or metalloid injected into the reactor in the form of gas.

2. The process as claimed in claim 1, characterized in that the homogeneous CNT powder is obtained by placing the CNTs in a fluidized bed in a reactor while injecting a gas into this reactor.

3. The process as claimed in claim 2, further comprising converting the precursor in the liquid state to the vapor phase by heating and injecting the precursor into the reactor in the form of gas.

4. The process as claimed in claim 1, further comprising introducing the CNTs into the reactor cold, injecting gas to purge the CNTs, placing them in a fluidized bed and thus forming a homogeneous powder, heating the reactor to a predefined temperature of less than 1000° C., injecting the precursor into the reactor whereby the precursor decomposes at the surface of the CNTs.

5. The process as claimed in claim 4, characterized in that the gas to purge the CNTs is an inert gas, and, when the predefined temperature is reached, the purging with the inert gas is stopped and hydrogen gas is injected.

6. The process as claimed in claim 1, characterized in that the CNTs are introduced into the reactor in a measured amount for batchwise production or continuously for continuous production.

7. The process as claimed in claim 1, characterized in that the precursor is tetramethylsilane (TMS) and silicon is deposited on the CNTs.

8. The process as claimed in claim 7, characterized in that tetramethylsilane (TMS) in vapor form is conveyed by a stream of hydrogen.

9. The process as claimed in claim 1, characterized in that the precursor is trimethylboron or triethylboron and boron is deposited on the CNTs.

10-13. (canceled)

14. The process as claimed in claim 1, characterized in that the precursor is trimethylboron or triethylboron and boron is deposited on the CNTs.

15. The process as claimed in claim 1, characterized in that the precursor is diethylgermanium or tetraethylgermanium and germanium is deposited on the CNTs.

16. The process as claimed in claim 1, characterized in that the precursor is trimethylaluminum and aluminum is deposited on the CNTs.

17. The process as claimed in claim 1, characterized in that the precursor is copper acetylacetonate or copper hexafluoroacetylacetonate-2-methyl-2-hexen-3-yne and copper is deposited on the CNTs.

18. The process as claimed in claim 1, characterized in that the precursor is tetramethyltin and tin is deposited on the CNTs
